(19) United States
(12) Patent Application Publication
(10) Pub. No.: US 2019/0244242 A1
(43) Pub. Date: Aug. 8, 2019

(54) COMMUNICATION APPARATUS, INFORMATION TERMINAL, SYSTEM, METHOD FOR CONTROLLING COMMUNICATION APPARATUS, METHOD FOR CONTROLLING INFORMATION TERMINAL, AND METHOD FOR CONTROLLING SYSTEM

(71) Applicant: CANON KABUSHIKI KAISHA, Tokyo (JP)

(72) Inventor: Seiji Takahashi, Kawasaki-shi (JP)

(21) Appl. No.: 16/258,379

(22) Filed: Jan. 25, 2019

(30) Foreign Application Priority Data
Feb. 5, 2018 (JP) 2018-018171

(51) Int. Cl. G06Q 30/02; H04L 29/08; G06Q 30/00

(52) U.S. Cl. CPC G06Q 30/0248; G06Q 30/018; H04L 67/04

(57) ABSTRACT

A communication apparatus includes a transmission unit that transmits data to an external apparatus by either a first transmission method for transmitting the data by active scanning or a second transmission method for transmitting the data by passive scanning, and a control unit that, in a case where a number of external apparatuses increases, switches the transmission method of the transmission unit from the first transmission method to the second transmission method, and in a case where the number of external apparatuses decreases, switches the transmission method of the transmission unit from the second transmission method to the first transmission method.

### BACKGROUND

### Field

The present disclosure relates to a communication apparatus, an information terminal, a system, a method for controlling a communication apparatus, a method for controlling an information terminal, and a method for controlling a system.

### Description of the Related Art

Bluetooth® Low Energy is known as a low power consumption wireless communication specification. Uses such as distributing advertisement or coupon information to an unspecified large number of apparatuses by Bluetooth® Low Energy communication are attracting attention. Active scanning and passive scanning are two Bluetooth® Low Energy communication methods for apparatuses having no communication connection established therebetween. In active scanning, an advertiser device broadcasts an advertisement, and scanner devices receiving the advertisement transmit scan requests to the advertiser device. Receiving the scan requests, the advertiser device transmits scan responses to the scanner devices. In passive scanning, the advertiser device broadcasts an advertisement, and scanner devices receive the advertisement. According to the specification extended by the Bluetooth® Low Energy specification version 5.0, in active scanning, the scan responses (AUX_SCAN_RSP) contain user data. In passive scanning, the advertisement (AUX_ADV_IND) contains user data. Details of the Bluetooth® Low Energy specification version 5.0 are discussed on the website (BLUETOOTH CORE SPECIFICATION Version 5.0, [online], Dec. 6, 2016, [searched on Nov. 15, 2017], the Internet <URL: https://www.bluetooth.org/DocMan/handlers/DownloadDoc.ashx?doc_id=421043>).

In the foregoing active scanning, the advertiser device unicasts the scan responses to the scanner devices. If there are many scanner devices, the communication load of the advertiser device therefore increases, compared to in passive scanning. The advertiser device in passive scanning broadcasts the advertisement regardless of the presence or absence of scanner devices. If there are not many scanner devices, the communication load of the advertiser device therefore increases, compared to in active scanning.

### SUMMARY

According to an aspect of the present disclosure, a communication apparatus includes a transmission unit configured to transmit data to an external apparatus by either a first transmission method for transmitting the data by active scanning or a second transmission method for transmitting the data by passive scanning, and a control unit configured to, in a case where a number of external apparatuses increases, switch the transmission method of the transmission unit from the first transmission method to the second transmission method, and in a case where the number of external apparatuses decreases, switch the transmission method of the transmission unit from the second transmission method to the first transmission method.

Further features will become apparent from the following description of exemplary embodiments with reference to the attached drawings.

### BRIEF DESCRIPTION OF THE DRAWINGS

FIG. 1 is a diagram illustrating an example of a configuration of a communication apparatus and an information terminal.

FIG. 2 is a sequence diagram illustrating an example of communication processing between the communication apparatus and information terminals.

FIG. 3 is a flowchart illustrating an example of processing of the communication apparatus.

FIG. 4 is a flowchart illustrating an example of processing of the information terminals.

### DESCRIPTION OF THE EMBODIMENTS

A communication system according to a first exemplary embodiment includes a communication apparatus 100 and an information terminal 150. The communication apparatus 100 can be an apparatus having an advertiser function in accordance with the Bluetooth® Low Energy specification. The information terminal 150 can be an apparatus having a scanner function in accordance with the Bluetooth® Low Energy specification. The information terminal 150 can be, but not limited to, a smartphone terminal, a tablet terminal, a game device, and a digital camera. The information terminal 150 is an example of an external apparatus as seen from the communication apparatus 100. The communication apparatus 100 is an example of an external apparatus as seen from the information terminal 150.

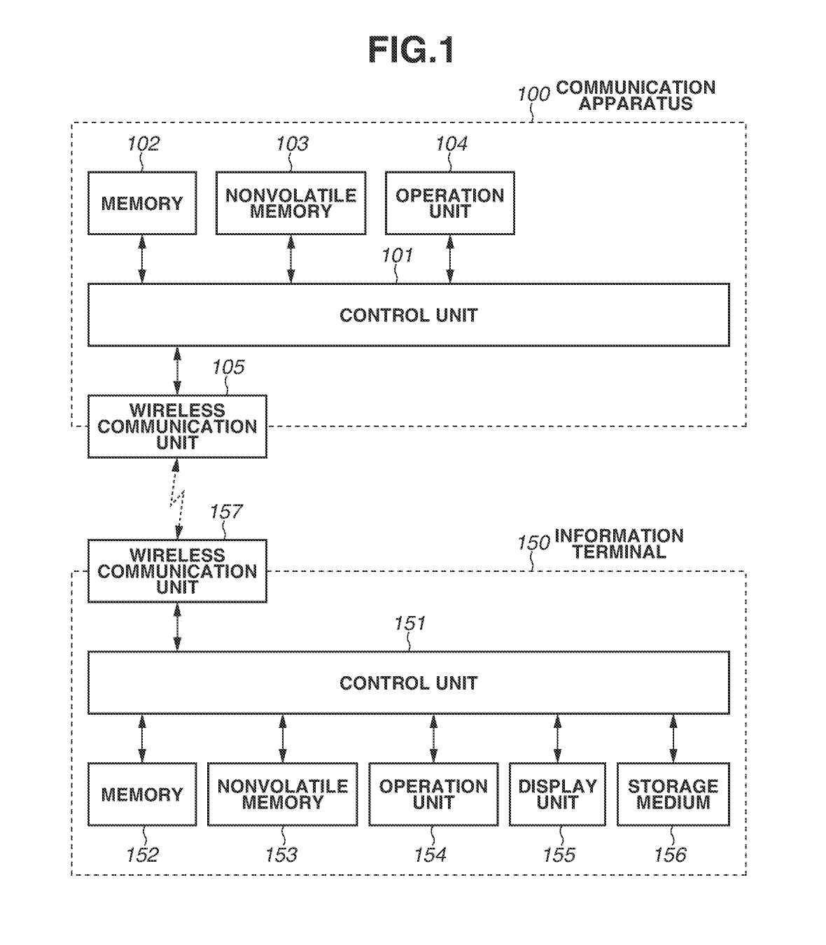

A configuration of the communication apparatus 100 will initially be described with reference to FIG. 1. FIG. 1 is a diagram illustrating an example of a configuration of the communication apparatus 100 and the information terminal 150. The communication apparatus 100 includes a control unit 101, a memory 102, a nonvolatile memory 103, an operation unit 104, and a wireless communication unit 105.

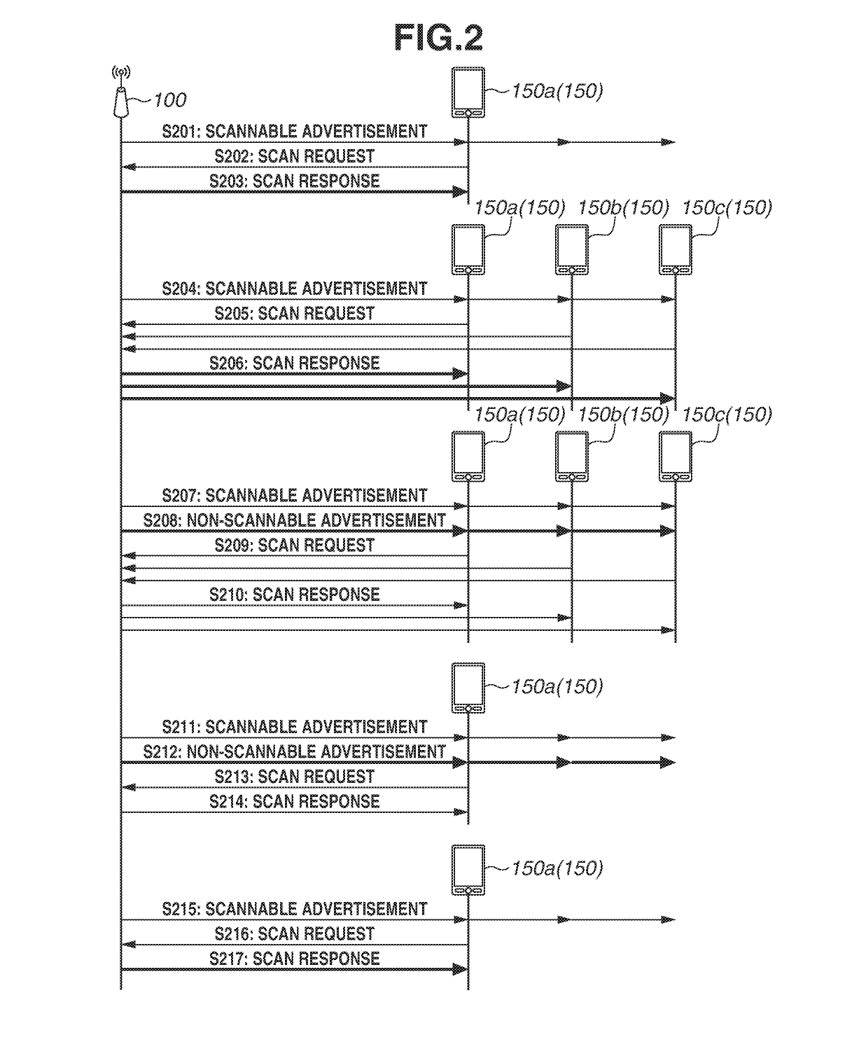

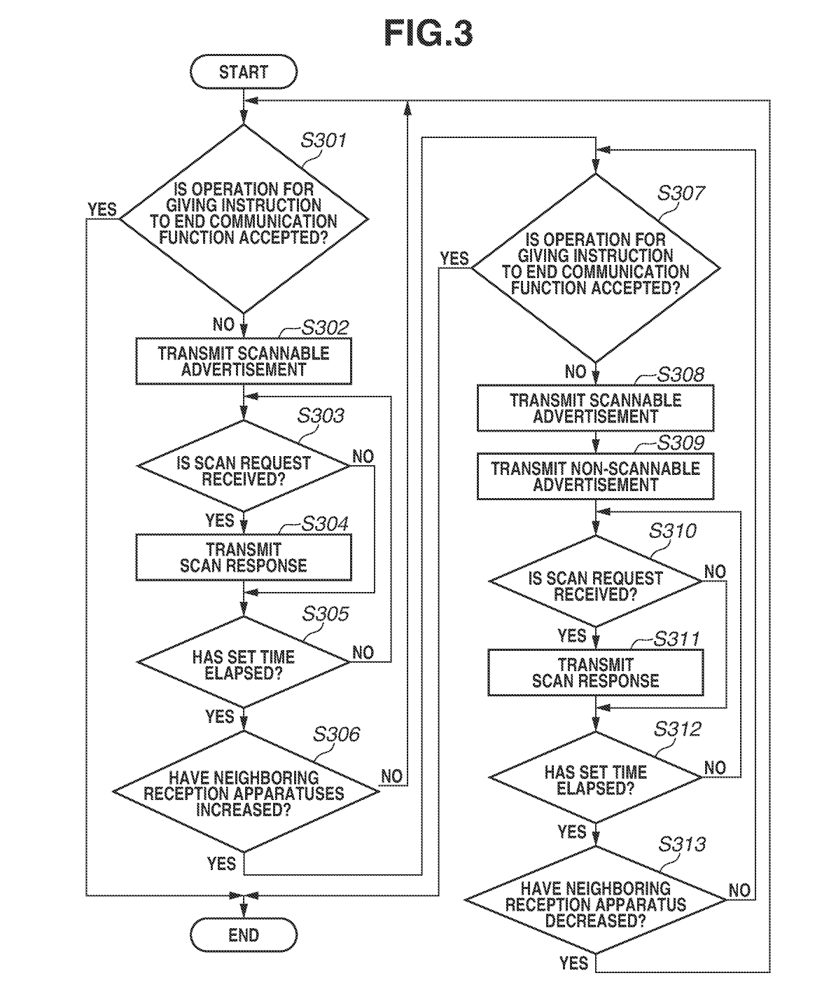

The control unit 101 controls the entire communication apparatus 100. Various functions of the communication apparatus 100 and processing of the communication apparatus 100 illustrated in FIGS. 2 and 3 are implemented by the control unit 101 performing processing based on a program stored in the nonvolatile memory 103.

The memory 102 is used as a buffer memory for temporarily storing various types of data and as a work area of the control unit 101.

The nonvolatile memory 103 is an electrically erasable and recordable nonvolatile memory, and stores the program to be executed by the control unit 101. The nonvolatile memory 103 is an example of a storage medium.

The operation unit 104 is used to accept instructions to the communication apparatus 100 from a user. For example, the operation unit 104 includes a power button for the user to provided instructions to power on/off the communication apparatus 100, and an operation button to provide instructions to turn on/off a communication function.

The wireless communication unit 105 includes, for example, an antenna for wireless communication, a modulation/demodulation circuit for processing wireless signals, and a communication controller. The wireless communication unit 105 implements short range wireless communication by outputting a modulated wireless signal from the antenna and demodulating a wireless signal received by the antenna. In the present exemplary embodiment, the low power consumption Bluetooth® Low Energy specification version 5.0 is employed for the communication method. The control unit 101 controls the wireless communication unit 105 to implement communication with the information terminal 150.

Next, a configuration of the information terminal 150 will be described with reference to FIG. 1. The information terminal 150 includes a control unit 151, a memory 152, a nonvolatile memory 153, an operation unit 154, a display unit 155, a storage medium 156, and a wireless communication unit 157.

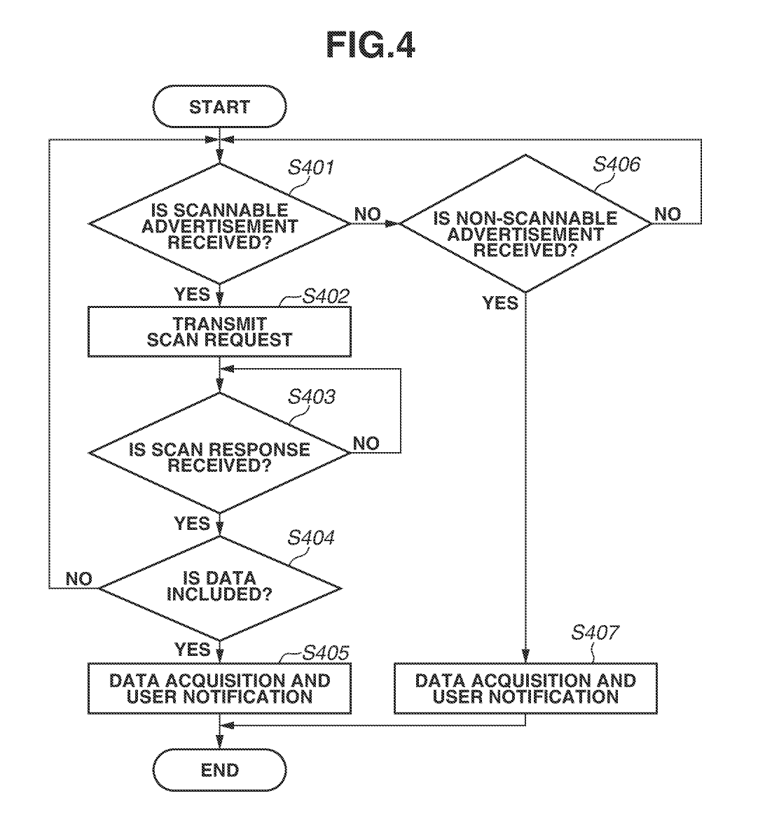

The control unit 151 controls the entire information terminal 150. Various functions of the information terminal 150 and processing of the information terminal 150 illustrated in FIGS. 2 and 4 are implemented by the control unit 151 performing processing based on a program stored in the nonvolatile memory 153.

The memory 152 is used as a buffer memory for temporarily storing various types of data and as a work area of the control unit 151.

The nonvolatile memory 153 is an electrically erasable and recordable nonvolatile memory, and stores the program to be executed by the control unit 151. The nonvolatile memory 153 is an example of a storage medium.

The operation unit 154 accepts instructions to the information terminal 150 from a user. For example, the operation unit 154 includes a power button for the user to provide instructions to power on/off the information terminal 150, and an operation button to provide instructions for screen transition. A touch panel formed on the display unit 155 is also included in the operation unit 154.

The display unit 155 provides a graphical user interface (GUI) display for interactive operations. The display unit 155 does not necessarily need to be built into the information terminal 150. The information terminal 150 can have at least a display control function for controlling the display unit 155.

The storage medium 156 can store various types of data. The storage medium 156 can be configured to be detachably attachable to the information terminal 150. The storage medium 156 can be built into the information terminal 150. The information terminal 150 can include at least a unit for accessing the storage medium 156.

The wireless communication unit 157 includes, for example, an antenna for wireless communication, a modulation/demodulation circuit for processing wireless signals, and a communication controller. The wireless communication unit 157 implements short range wireless communication in accordance with the Institute of Electrical and Electronics Engineers (IEEE) 802.15 standard (Bluetooth®) by outputting a modulated wireless signal from the antenna and demodulating a wireless signal received by the antenna. In the present exemplary embodiment, the Bluetooth® Low Energy specification version 5.0 which is a low power consumption specification is employed for Bluetooth® communication. The control unit 151 controls the wireless communication unit 157 to implement communication with the communication apparatus 100.

While the configuration of the communication apparatus 100 and the information terminal 150 has been described above, the communication apparatus 100 and the information terminal 150 are not necessarily limited to such respective configurations. For example, the control unit 101, the control unit 151, the nonvolatile memory 103, and the nonvolatile memory 153 do not necessarily need to be implemented by a single piece of hardware. A plurality of pieces of hardware can share processing and function as a single unit. Conversely, a single piece of hardware can perform various types of processing to function as a plurality of units.

Next, communication processing between the communication apparatus 100 and the information terminal 150 will be described with reference to FIG. 2. FIG. 2 is a sequence diagram illustrating an example of the communication processing between the communication apparatus 100 and the information terminal 150. A first information terminal 150a, a second information terminal 150b, and a third information terminal 150c illustrated in FIG. 2 have the same configuration as that of the information terminal 150 described with reference to FIG. 1.

The communication processing illustrated in FIG. 2 is started by the control unit 101 of the communication apparatus 100 accepting an operation for providing an instruction to start the communication function via the operation unit 104.

Presume that, during a period when steps S201 to S203 are performed, the first information terminal 150a is present at a position capable of Bluetooth® Low Energy wireless communication with the communication apparatus 100.

In step S201, the communication apparatus 100 transmits a scannable advertisement to neighboring apparatuses. The scannable advertisement is a packet defined as ADV_EXT_IND and AUX_ADV_IND in the Bluetooth® Low Energy specification, and has an AdvMode value of 10b. The first information terminal 150a receives the scannable advertisement from the communication apparatus 100.

In step S202, the first information terminal 150a transmits a scan request to the communication apparatus 100. The scan request is a packet defined as AUX_SCAN_REQ in the Bluetooth® Low Energy specification. The communication apparatus 100 receives the scan request from the first information terminal 150a.

In step S203, the communication apparatus 100 transmits a scan response to the first information terminal 150a. The scan response is a packet defined as AUX_SCAN_RSP in the Bluetooth® Low Energy specification. The communication apparatus 100 includes predetermined data into AdvData of the AUX_SCAN_RSP packet. An example of the predetermined data is Uniform Resource Locator (URL) information. Examples of the URL to be the predetermined data include a URL of product information and a URL for coupon distribution. The predetermined data can be product information or coupon information. The first information terminal 150a receives the scan response from the communication apparatus 100.

Presume that, during a period when steps S204 to S210 are performed, the first information terminal 150a, the second information terminal 150b, and the third information terminal 150c are present at positions capable of Bluetooth® Low Energy wireless communication with the communication apparatus 100.

In step S204, the communication apparatus 100 transmits a scannable advertisement to neighboring apparatuses. Each of the first to third information terminals 150a to 150c receives the scannable advertisement from the communication apparatus 100.

In step S205, the first to third information terminals 150a to 150c each transmit a scan request to the communication apparatus 100. The communication apparatus 100 receives the scan requests from the respective first to third information terminals 150a to 150c.

In step S206, the communication apparatus 100 transmits a scan response to each of the first to third information terminals 150a to 150c. As in step S203, the communication apparatus 100 includes the foregoing predetermined data into the scan response. Each of the first to third information terminals 150a to 150c receives the scan response from the communication apparatus 100.

In the period when steps S204 to S206 are performed, the number of information terminals 150 present at positions capable of Bluetooth® Low Energy communication with the communication apparatus 100 increases, compared to in the period when steps S201 to S203 are performed. Steps S207 to S210 will be described on the assumption that the communication apparatus 100 determines that the number of information terminal 150 present near the communication apparatus 100 has increased, based on the communications in step S205.

In step S207, the communication apparatus 100 transmits a scannable advertisement to neighboring apparatuses.

In step S208, the communication apparatus 100 transmits a non-scannable advertisement to neighboring apparatuses. The non-scannable advertisement is a packet defined as ADV_EXT_IND and AUX_ADV_IND in the Bluetooth® Low Energy specification, and has an AdvMode value of 00b. The communication apparatus 100 includes the foregoing predetermined data into AdvData of the AUX_ADV_IND packet. Each of the first to third information terminals 150a to 150c receives the non-scannable advertisement from the communication apparatus 100.

In step S209, each of the first to third information terminals 150a to 150c transmits a scan request to the communication apparatus 100. The communication apparatus 100 receives the scan requests from the respective first to third information terminals 150a to 150c.

In step S210, the communication apparatus 100 transmits a scan response to each of the first to third information terminals 150a to 150c. The communication apparatus 100 does not include the foregoing predetermined data into AdvData of the scan response transmitted in step S210. The first to third information terminals 150a to 150c each receive the scan response not including the predetermined data in AdvData from the communication apparatus 100.

Presume that, during a period when steps S211 to S217 are performed, the first information terminal 150a is present at a position capable of Bluetooth® Low Energy wireless communication with the communication apparatus 100, but not the second information terminal 150b or the third information terminal 150c.

In step S211, the communication apparatus 100 transmits a scannable advertisement to neighboring apparatuses. The first information terminal 150a receives the scannable advertisement from the communication apparatus 100.

In step S212, the communication apparatus 100 transmits a non-scannable advertisement to neighboring apparatuses. Like the non-scannable advertisement transmitted in step S208, the non-scannable advertisement transmitted in step S212 includes the foregoing predetermined data. The first information terminal 150a receives the non-scannable advertisement from the communication apparatus 100.

In step S213, the first information terminal 150a transmits a scan request to the communication apparatus 100. The scan request transmitted in step S213 is a signal corresponding to the scannable advertisement in step S211. The communication apparatus 100 receives the scan request from the first information terminal 150a.

In step S214, the communication apparatus 100 transmits a scan response to the first information terminal 150a. The communication apparatus 100 does not include the foregoing predetermined data into AdvData of the scan response transmitted in step S214. The first information terminal 150a receives the scan response not including the predetermined data from the communication apparatus 100.

In the period when steps S211 to S214 are performed, the number of information terminals 150 present at positions capable of Bluetooth® Low Energy communication with the communication apparatus 100 decreases, compared to in the period when steps S207 to S210 are performed. Steps S215 to S217 will be described on the assumption that the communication apparatus 100 determines that the number of information terminals 150 lying near the communication apparatus 100 has decreased, based on the communication in step S213.

In step S215, the communication apparatus 100 transmits a scannable advertisement to neighboring apparatuses. The first information terminal 150a receives the scannable advertisement from the communication apparatus 100.

In step S216, the first information terminal 150a transmits a scan request to the communication apparatus 100. The communication apparatus 100 receives the scan request from the first information terminal 150a.

In step S217, the communication apparatus 100 transmits a scan response to the first information terminal 150a. As in steps S203 and S206, the communication apparatus 100 includes the foregoing predetermined data into the scan response transmitted in step S217. The first information terminal 150a receives the scan response including the predetermined data from the communication apparatus 100.

Next, processing of the communication apparatus 100 for implementing the processing of FIG. 2 will be described with reference to FIG. 3. FIG. 3 is a flowchart illustrating an example of the processing of the communication apparatus 100. The processing of FIG. 3 is started by the control unit 101 of the communication apparatus 100 accepting an operation for giving an instruction to start the communication function via the operation unit 104.

In step S301, the control unit 101 determines whether an operation for providing an instruction to end the communication function is accepted via the operation unit 104. If the control unit 101 determines that an operation for giving an instruction to end the communication function is accepted (YES in step S301), the processing of FIG. 3 ends. If the control unit 101 determines that an operation for giving an instruction to end the communication function is not accepted (NO in step S301), the processing proceeds to step S302.

In step S302, the control unit 101 broadcasts a scannable advertisement to neighboring reception apparatuses via the wireless communication unit 105. The scannable advertisement is a packet defined as ADV_EXT_IND and AUX_ADV_IND in the Bluetooth® Low Energy specification, and has an AdvMode value of 10b. The neighboring reception apparatuses refer to apparatuses capable of Bluetooth® Low Energy wireless communication with the communication apparatus 100. The processing of step S302 corresponds to the processing of steps S201, S204, and S215 in FIG. 2. In the present exemplary embodiment, apparatuses that receive the scannable advertisement and neighboring reception apparatuses are information terminals 150. The scannable advertisement transmitted in step S302 is an example of a first advertisement signal not including predetermined data.

In step S303, the control unit 101 determines whether a scan request is received from another apparatus via the wireless communication unit 105. If the control unit 101 determines that a scan request is received (YES in step S303), the processing proceeds to step S304. If the control unit 101 determines that a scan request is not received (NO in step S303), the processing proceeds to step S305. The scan request received in step S303 is an example of a request signal.

In step S304, the control unit 101 unicasts a scan response to the apparatus that is the source of the scan request received in step S303 via the wireless communication unit 105. The scan response is a packet defined as AUX_SCAN_RSP in the Bluetooth® Low Energy specification. The control unit 101 includes predetermined data into AdvData of the scan response. As described above, an example of the predetermined data is URL information. The processing of step S304 corresponds to the processing of steps S203, S206, and S217 in FIG. 2. In the present exemplary embodiment, the source apparatus of the scan request is an information terminal 150. The scan response transmitted in step S304 is an example of a response signal including predetermined data.

In step S305, the control unit 101 determines whether a set time has elapsed since the processing of step S302 is performed. If the control unit 101 determines that the set time has elapsed (YES in step S305), the processing proceeds to step S306. If the control unit 101 determines that the set time has not elapsed (NO in step S305), the processing proceeds to step S303. The control unit 101 obtains the set time, for example, from the nonvolatile memory 103. The set time in step S305 is an example of a first time.

In step S306, the control unit 101 determines whether neighboring reception apparatuses have increased. For example, if the number of times a scan request is received in step S303 within the set time is greater than or equal to a first number of times, the control unit 101 determines that neighboring reception apparatuses have increased. The control unit 101 obtains the first number of times, for example, from the nonvolatile memory 103. If the control unit 101 determines that neighboring reception apparatuses have increased (YES in step S306), the processing proceeds to step S307. If the control unit 101 determines that neighboring reception apparatuses have not increased (NO in step S306), the processing proceeds to step S301. By repeating the processing of steps S301 to S306, the control unit 101 regularly transmits a scannable advertisement in step S302.

In step S307, the control unit 101 determines whether an operation for providing an instruction to end the communication function is accepted via the operation unit 104. If the control unit 101 determines that an operation for providing an instruction to end the communication function is accepted (YES in step S307), the processing of FIG. 3 ends. If the control unit 101 determines that an operation for providing an instruction to end the communication function is not accepted (NO in step S307), the processing proceeds to step S308.

In step S308, the control unit 101 broadcasts a scannable advertisement to neighboring reception apparatuses via the wireless communication unit 105. The processing of step S308 corresponds to the processing of steps S207 and S211 in FIG. 2. The scannable advertisement transmitted in step S308 is an example of a third advertisement signal not including predetermined data.

In step S309, the control unit 101 broadcasts a non-scannable advertisement to neighboring reception apparatuses via the wireless communication unit 105. The non-scannable advertisement is a packet defined as ADV_EXT_IND and AUX_ADV_IND in the Bluetooth® Low Energy specification, and has an AdvMode value of 00b. The control unit 101 includes the foregoing predetermined data into AdvData of the AUX_ADV_IND packet. The processing of step S309 corresponds to the processing of steps S208 and S212 in FIG. 2. In the present exemplary embodiment, apparatuses that receive the non-scannable advertisement are information terminals 150. The non-scannable advertisement transmitted in step S309 is an example of a second advertisement signal including predetermined data.

In step S310, the control unit 101 determines whether a scan request is received from another apparatus via the wireless communication unit 105. If the control unit 101 determines that a scan request is received (YES in step S310), the processing proceeds to step S311. If the control unit 101 determines that a scan request is not received (NO in step S310), the processing proceeds to step S312.

In step S311, the control unit 101 unicasts a scan response to the apparatus that is the source of the scan request received in step S310 via the wireless communication unit 105. The scan response is a packet defined as AUX_SCAN_RSP in the Bluetooth® Low Energy specification. The control unit 101 includes no data into AdvData of the scan response transmitted in step S311. The processing of step S311 corresponds to the processing of steps S210 and S214 in FIG. 2.

In step S312, the control unit 101 determines whether a set time has elapsed since the processing of step S308 is performed. If the control unit 101 determines that the set time has elapsed (YES in step S312), the processing proceeds to step S313. If the control unit 101 determines that the set time has not elapsed (NO in step S312), the processing proceeds to step S310. The control unit 101 obtains the set time, for example, from the nonvolatile memory 103. The set time in step S305 and the set time in step S312 can be the same or different. The set time in step S312 is an example of a second time.

In step S313, the control unit 101 determines whether neighboring reception apparatuses have decreased. For example, if the number of times a scan request is received in step S310 within the set time is less than or equal to a second number of times, the control unit 101 determines that neighboring reception apparatuses have decreased. The control unit 101 obtains the second number of times, for example, from the nonvolatile memory 103. If the control unit 101 determines that neighboring reception apparatuses have decreased (YES in step S313), the processing proceeds to step S301. If the control unit 101 determines that neighboring reception apparatuses have not decreased (NO in step S313), the processing proceeds to step S307. By repeating the processing of steps S307 to S313, the control unit 101 regularly transmits a scannable advertisement in step S308. By repeating the processing of steps S307 to S313, the control unit 101 regularly transmits a non-scannable advertisement in step S309.

The processing of steps S302 to S304 is an example of processing for transmitting an advertisement by active scanning. The processing of steps S302 to S304 is also an example of processing by a first transmission method for transmitting predetermined data by active scanning.

The processing of step S309 is an example of processing for transmitting an advertisement by passive scanning. The processing of step S309 is also an example of processing by a second transmission method for transmitting predetermined data by passive scanning.

The processing of step S306 is an example of processing for performing control to switch from the first transmission method to the second transmission method when the number of apparatuses capable of Bluetooth® Low Energy communication with the communication apparatus 100 increases. The processing of step S313 is an example of processing for performing control to switch from the second transmission method to the first transmission method when the number of apparatuses capable of Bluetooth® Low Energy communication with the communication apparatus 100 decreases. The processing of steps S306 and S313 is an example of determination processing for determining a change in the number of information terminals 150 based on the number of times a signal is received from the information terminals 150.

Next, processing of the information terminal 150 for implementing the processing of FIG. 2 will be described with reference to FIG. 4. FIG. 4 is a flowchart illustrating an example of the processing of the information terminal 150. The processing of FIG. 4 is started by the control unit 151 of the information terminal 150 accepting an operation for providing an instruction to start the communication function via the operation unit 154.

In step S401, the control unit 151 determines whether a scannable advertisement is received from another apparatus via the wireless communication unit 157. If the control unit 151 determines that a scannable advertisement is received (YES in step S401), the processing proceeds to step S402. If the control unit 151 determines that a scannable advertisement is not received (NO in step S401), the processing proceeds to step S406. In the present exemplary embodiment, another apparatus in the description of FIG. 4 refers to the communication apparatus 100.

In step S402, the control unit 151 transmits a scan request to the apparatus that is the source of the scannable advertisement received in step S401 via the wireless communication unit 157. The scan request is a packet defined as AUX_SCAN_REQ in the Bluetooth® Low Energy specification. The processing of step S402 corresponds to the processing of steps S202, S205, S209, S213, and S216 in FIG. 2.

In step S403, the control unit 151 determines whether a scan response is received from the apparatus that is the source of the scannable advertisement received in step S401 via the wireless communication unit 157. If the control unit 151 determines that a scan response is received (YES in step S403), the processing proceeds to step S404. If the control unit 151 determines that a scan response is not received (NO in step S403), the processing returns to step S403. The scan response is a packet defined as AUX_SCAN_RSP in the Bluetooth® Low Energy specification.

In step S404, the control unit 151 determines whether data is included in AdvData of the AUX_SCAN_RSP packet that is the scan response received in step S403. If the control unit 151 determines that data is included (YES in step S404), the processing proceeds to step S405. If the control unit 151 determines that data is not included (NO in step S404), the processing proceeds to step S401.

In step S405, the control unit 151 obtains predetermined data included in AdvData of the AUX_SCAN_RSP packet that is the scan response received in step S403. For example, the control unit 151 then performs control to display the predetermined data obtained from the scan response on the display unit 155 for user notification. The processing for obtaining the predetermined data in step S405 is an example of first acquisition processing.

In step S406, the control unit 151 determines whether a non-scannable advertisement is received from another apparatus via the wireless communication unit 157. If the control unit 151 determines that a non-scannable advertisement is received (YES in step S406), the processing proceeds to step S407. If the control unit 151 determines that a non-scannable advertisement is not received (NO in step S406), the processing proceeds to step S401.

In step S407, the control unit 151 obtains predetermined data included in the AUX_ADV_IND packet that is the non-scannable advertisement received in step S406. For example, the control unit 151 then performs control to display the predetermined data obtained from the non-scannable advertisement on the display unit 155 for user notification. The processing for obtaining the predetermined data in step S407 is an example of second acquisition processing. The processing of steps S403 and S406 is an example of reception processing for receiving predetermined data.

In such a manner, the information terminal 150 notifies the user of the data in a predetermined area of the received non-scannable advertisement.

As described above, the communication apparatus 100 switches the transmission method in transmitting predetermined data based on a change in the number of information terminals 150. A communication load can thereby be suppressed. A detailed description thereof will be given below.

If the number of information terminals 150 increases, the communication apparatus 100 according to the present exemplary embodiment switches the method for transmitting predetermined data to the information terminals 150 from a method for transmitting the predetermined data by active scanning to a method for transmitting the predetermined data by passive scanning. The communication apparatus 100 then transmits the predetermined data by using a non-scannable advertisement including the predetermined data. The communication load therefore remains unchanged even when the information terminals 150 increases.

Conversely, presume that the communication apparatus 100 transmits the predetermined data by active scanning when the number of information terminals 150 increases. In such a case, the communication load increases since the communication apparatus 100 transmits the predetermined data to each individual information terminal 150. This can cause collisions and an increase in the power consumption of the communication apparatus 100.

Compared to the case of using active scanning when the number of information terminals 150 increases, the communication apparatus 100 according to the present exemplary embodiment can suppress the communication load. The communication apparatus 100 according to the present exemplary embodiment can suppress the occurrence of collisions and suppress an increase in the power consumption of the communication apparatus 100.

If the number of information terminals 150 decreases, the communication apparatus 100 according to the present exemplary embodiment switches the method for transmitting predetermined data to the information terminals 150 from the method for transmitting the predetermined data by passive scanning to the method for transmitting the predetermined data by active scanning. If there is no information terminal 150 or there are not many information terminals 150, minimum communications are performed without the occurrence of needless communications. The communication apparatus 100 can thus suppress the communication load.

The communication apparatus 100 determines an increase or decrease in the number of information terminals 150 based on the number of times a scan request is received from the information terminals 150. The communication apparatus 100 can thus easily determine an increase or decrease in the number of information terminals 150. No special function needs to be added to the information terminals 150.

In the foregoing exemplary embodiment, if neighboring reception apparatuses are determined to have increased in step S306, the control unit 101 regularly transmits a scannable advertisement and a non-scannable advertisement in steps S308 and S309 at the same time intervals. However, the control unit 101 can make the time intervals at which a scannable advertisement is transmitted different from the time intervals at which a non-scannable advertisement is transmitted. For example, the control unit 101 can make the time intervals at which a non-scannable advertisement is transmitted longer than the time intervals at which a scannable advertisement is transmitted. This can suppress excessive transmission of non-scannable advertisement including predetermined data.

In the foregoing exemplary embodiment, in steps S306 and S313 of FIG. 3, the control unit 101 determines an increase or decrease of apparatuses capable of Bluetooth® Low Energy communication with the communication apparatus 100 based on the number of times a scan request is received within a set time, and the first number of times or the second number of times. However, the control unit 101 can determine an increase or decrease of apparatuses capable of Bluetooth® Low Energy communication with the communication apparatus 100 based on a rate of change, such as a rate of increase and a rate of decrease in the number of times a scan request is received within a set time.

For example, in step S306 of FIG. 3, the control unit 101 obtains the rate of increase in the number of times a scan request is received within the set time based on the number of times a scan request is received in step S303 within the set time. If the obtained rate of increase is greater than or equal to a set rate of increase, the control unit 101 determines that the number of apparatuses capable of Bluetooth® Low Energy wireless communication with the communication apparatus 100 has increased.

In step S313 of FIG. 3, the control unit 101 obtains the rate of decrease in the number of times a scan request is received within the set time based on the number of times a scan request is received in step S310 within the set time. If the obtained rate of decrease is greater than or equal to a set rate of decrease, the control unit 101 determines that the number of apparatuses capable of Bluetooth® Low Energy wireless communication with the communication apparatus 100 has decreased. The control unit 101 obtains the set rate of increase and the set rate of decrease, for example, from the nonvolatile memory 103.

According to the foregoing exemplary embodiments, a communication load can be suppressed.

### Other Embodiments

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-018171, filed Feb. 5, 2018, which is hereby incorporated by reference herein in its entirety.

What is claimed is:

1. A communication apparatus comprising:
a transmission unit configured to transmit data to an external apparatus by either a first transmission method for transmitting the data by active scanning or a second transmission method for transmitting the data by passive scanning; and
a control unit configured to, in a case where a number of external apparatuses increases, switch a transmission method of the transmission unit from the first transmission method to the second transmission method, and in a case where the number of external apparatuses decreases, switch the transmission method of the transmission unit from the second transmission method to the first transmission method.

2. The communication apparatus according to claim 1,
wherein the first transmission method includes transmitting a first advertising signal not including the data, receiving a request signal transmitted from the external apparatus receiving the first signal, and transmitting the data to the external apparatus that is a source of the request signal, and
wherein the second transmission method includes transmitting a second advertising signal including the data.

3. The communication apparatus according to claim 2,
wherein the transmission unit is configured to periodically transmit the first advertising signal, and
wherein the control unit is configured to, in a case where the number of external apparatuses is determined to have increased based on a number of times a request signal is received from the external apparatuses, perform control to switch from the first transmission method to the second transmission method.

4. The communication apparatus according to claim 1,
wherein the transmission unit is configured to, in a case where the data is transmitted by the second transmission method, periodically transmit a third advertising signal not including the data, and
wherein the control unit is configured to, in a case where the number of external apparatuses is determined to have decreased based on a number of times a signal transmitted from the external apparatuses receiving the third advertising signal is received, perform control to switch the transmission method of the transmission unit from the second transmission method to the first transmission method.

5. The communication apparatus according to claim 1, further comprising a determination unit configured to determine a change in the number of external apparatuses based on a number of times a signal is received from the external apparatuses,
wherein the control unit is configured to, in a case where the determination unit determines that the number of external apparatuses has increased, perform control to switch the transmission method of the transmission unit from the first transmission method to the second transmission method, and
wherein the control unit is configured to, in a case where the determination unit determines that the number of external apparatuses decreases, perform control to switch the transmission method of the transmission unit from the second transmission method to the first transmission method.

6. The communication apparatus according to claim 5, wherein the determination unit is configured to, in a case where the number of times the signal is received from the external apparatuses within a first time is greater than or equal to a first number of times, determine that the number of external apparatuses has increased, and in a case where the number of times the signal is received from the external apparatuses within a second time is less than or equal to a second number of times, determine that the number of external apparatuses has decreased.

7. The communication apparatus according to claim 5, wherein the determination unit is configured to, in a case where a rate of increase in the number of times the signal is received from the external apparatuses within a first time is greater than or equal to a set rate of increase, determine that the number of external apparatuses has increased, and in a case where a rate of decrease in the number of times the signal is received from the external apparatuses within a second time is greater than or equal to a set rate of decrease, determine that the number of external apparatuses has decreased.

8. The communication apparatus according to claim 1, wherein the transmission unit is configured to use a Bluetooth® Low Energy communication method in the first and second transmission methods.

9. The communication apparatus according to claim 1, wherein the data is Uniform Resource Locator (URL) information.

10. An information terminal comprising:
a transmission unit configured to, in a case where a first advertising signal not including data is received from an external apparatus, transmit a request signal to the external apparatus;
a first acquisition unit configured to, in a case where a response signal including data is received from the external apparatus after transmission of the request signal, obtain the data from the response signal; and
a second acquisition unit configured to, in a case where a second advertising signal including data is received from the external apparatus, obtain the data included in the advertising signal.

11. A system comprising:
a communication apparatus; and
an information terminal,
wherein the communication apparatus includes:
a transmission unit configured to transmit data to the information terminal by either a first transmission method for transmitting the data by active scanning or a second transmission method for transmitting the data by passive scanning, and
a control unit configured to, in a case where a number of information terminals increases, switch a transmission method of the transmission unit from the first transmission method to the second transmission method, and in a case where the number of information terminals decreases, switch the transmission method of the transmission unit from the second transmission method to the first transmission method, and
wherein the information terminal includes a reception unit configured to receive the data transmitted by the communication apparatus.

12. A method for controlling a communication apparatus, comprising:
transmitting data to an external apparatus by either a first transmission method for transmitting the data by active scanning or a second transmission method for transmitting the data by passive scanning; and
performing control to, in a case where a number of external apparatuses increases, switch a transmission method from the first transmission method to the second transmission method, and in a case where the number of information terminals decreases, switch the transmission method from the second transmission method to the first transmission method.

13. A method for controlling an information terminal, comprising:
transmitting, in a case where a first advertising signal not including data is received from an external apparatus, a request signal to the external apparatus;
obtaining, in a case where a response signal including the data is received from the external apparatus after transmission of the request signal, the data from the response signal; and
obtaining, in a case where a second advertising signal including data is received from the external apparatus, obtaining the data included in the advertising signal.

14. A method for controlling a system including a communication apparatus and an information terminal, the method comprising:
transmitting data to the information terminal by either a first transmission method for transmitting the data by active scanning or a second transmission method for transmitting the data by passive scanning;
performing control to, in a case where a number of information terminals increases, switch a transmission method from the first transmission method to the second transmission method, and in a case where the number of information terminals decreases, switch the transmission method from the second transmission method to the first transmission method; and
receiving the data transmitted by the communication apparatus.
